(19) United States
(12) Patent Application Publication
(10) Pub. No.: US 2025/0286191 A1
(43) Pub. Date: Sep. 11, 2025

(54) VEHICLE

(71) Applicant: TOYOTA JIDOSHA KABUSHIKI KAISHA, Aichi-ken (JP)

(72) Inventors: Shingo AIJIMA, Sunto-gun (JP); Shigeyuki INOUE, Toyota-shi (JP)

(21) Appl. No.: 19/029,063

(22) Filed: Jan. 17, 2025

(30) Foreign Application Priority Data
Mar. 6, 2024 (JP) 2024-034053

(51) Int. Cl. H01M 50/242; B60K 1/04; H01M 50/249; H01M 50/271

(52) U.S. Cl. CPC H01M 50/242; B60K 1/04; H01M 50/249; H01M 50/271; B60K 2001/0438; H01M 2220/20

(57) ABSTRACT

A vehicle includes a vehicle body, a power storage device, and a cover member. The power storage device includes a power storage module and a lower case. The lower case includes a first protrusion that protrudes downward toward the cover member, the lower case being configured to support the power storage module. The cover member includes a second protrusion that protrudes upward toward the lower case.

### CROSS-REFERENCE TO RELATED APPLICATION

This application claims priority to Japanese Patent Application No. 2024-034053 filed on Mar. 6, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Application Publication No. 2021-138228 (JP 2021-138228 A) discloses a vehicle equipped with a battery case. The vehicle includes a protective member disposed outside the battery case in a vehicle width direction.

### SUMMARY

In JP 2021-138228 A, the protective member mitigates an impact from a side to the battery case, but there is room for improvement in mitigating an impact from below.

The present disclosure provides a vehicle capable of mitigating an impact from below.

A vehicle according to a first aspect of the present disclosure includes a vehicle body, a power storage device, and a cover member. The power storage device includes a power storage module and a lower case, the power storage device being fixed to a bottom portion of the vehicle body. The lower case includes at least one first protrusion that protrudes downward toward the cover member, the lower case being configured to support the power storage module. The cover member includes at least one second protrusion that protrudes upward toward the lower case, the cover member being configured to cover the power storage device from below and cover the lower case from below.

In the vehicle according to the first aspect of the present disclosure, as described above, the lower case includes at least one first protrusion that protrudes downward toward the cover member, and the cover member includes at least one second protrusion that protrudes upward toward the lower case. As a result, both the first protrusion and the second protrusion function as a buffer material from below, so that an impact from below on the power storage device can be effectively mitigated.

In the vehicle according to the first aspect of the present disclosure, the at least one first protrusion may include a plurality of first protrusions disposed side by side with a first space interposed between the first protrusions, and the at least one second protrusion may protrude at a position overlapping the first space in an up-down direction. With such a configuration, interference between the first protrusions and the second protrusion can be suppressed.

In the vehicle according to the first aspect of the present disclosure, the at least one second protrusion may include a plurality of second protrusions disposed side by side with a second space interposed between the second protrusions, and the at least one first protrusion may protrude at a position overlapping the second space in an up-down direction. With such a configuration, interference between the second protrusions and the first protrusion can be suppressed.

In the vehicle according to the first aspect of the present disclosure, the at least one first protrusion may be fixed to the lower case, and the at least one second protrusion may be fixed to the cover member. With such a configuration, rigidity of the power storage device can be improved as compared with a case where the first protrusion and the lower case are separated from each other and the second protrusion and the cover member are separated from each other.

The vehicle according to the first aspect of the present disclosure may further include a first buffer member provided between the at least one first protrusion and the cover member, and a second buffer member provided between the at least one second protrusion and the lower case. With such a configuration, the first buffer member and the second buffer member can more effectively mitigate the impact from below on the power storage device.

In the vehicle according to the first aspect of the present disclosure, the first buffer member may be fixed to at least one of the at least one first protrusion and the cover member, and the second buffer member may be fixed to at least one of the at least one second protrusion and the lower case. As a result, the first buffer member can be stably fixed between the first protrusion and the cover member. In addition, the second buffer member can be stably fixed between the second protrusion and the lower case.

In the vehicle according to the first aspect of the present disclosure, the lower case may include a case body portion to which the at least one first protrusion is fixed, the cover member may include a cover body portion to which the at least one second protrusion is fixed, the at least one first protrusion includes a first flange portion fixed to the case body portion, and a first protruding portion that protrudes downward from the first flange portion toward the cover member, and the at least one second protrusion includes a second flange portion fixed to the cover body portion, and a second protruding portion that protrudes upward from the second flange portion toward the lower case. With such a configuration, the first flange portion is provided, whereby rigidity of the first protrusion can be increased, and the first protrusion can be easily fixed to the case body portion. In addition, the second flange portion is provided, whereby rigidity of the second protrusion can be increased, and the second protrusion can be easily fixed to the cover body portion.

In the vehicle according to the first aspect of the present disclosure, at least a part of the first flange portion may overlap at least a part of the second flange portion in an up-down direction. With such a configuration, formation of a space (a space in which neither the first protrusion nor the second protrusion is disposed) between the first flange portion and the second flange portion in a direction in which the first protrusion and the second protrusion are arranged can be suppressed. As a result, transmission of the impact from below to the power storage module can be suppressed as compared with a case where the space is formed.

In the vehicle according to the first aspect of the present disclosure, a lower end of the at least one first protrusion may be positioned below an upper end of the at least one second protrusion. With such a configuration, a height of the power storage device in the up-down direction can be reduced.

In the vehicle according to the first aspect of the present disclosure, each of the at least one first protrusion and the at least one second protrusion may be provided to extend in a front-rear direction or a right-left direction of the vehicle body. With such a configuration, the first protrusion and the second protrusion can mitigate the impact from below on the power storage device over a relatively wide range of the bottom portion of the vehicle body.

According to the present disclosure, the impact from below on the power storage device including the lower case and the cover member can be mitigated.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic diagram showing a configuration of a vehicle and a power storage device according to an embodiment;

FIG. 2 is a cross-sectional view showing the configuration of the power storage device according to the embodiment;

FIG. 3 is a perspective view showing a configuration of a protrusion fixed to a lower case according to the embodiment;

FIG. 4 is a perspective view showing a configuration of a protrusion fixed to a share panel according to the embodiment; and

FIG. 5 is a partially enlarged view showing a detailed configuration in the vicinity of a protrusion in FIG. 2.

### DETAILED DESCRIPTION OF EMBODIMENTS

An embodiment of the present disclosure will be described with reference to the drawings. In the drawings to be referred to below, the same or corresponding members are denoted by the same number.

An X direction, a Y direction, and a Z direction shown in the present specification are directions orthogonal to each other. For example, the X direction and the Y direction are a front-rear direction and a right-left direction of a vehicle 900 described below, respectively. The Z direction is an up-down (vertical) direction. The X direction and the Y direction may be the right-left direction and the front-rear direction of the vehicle 900, respectively.

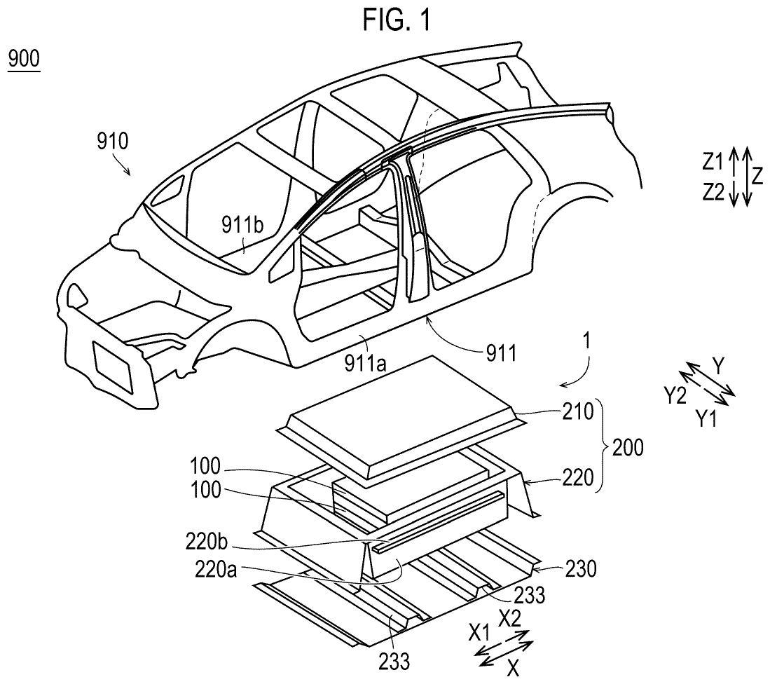

FIG. 1 is a schematic perspective view showing a configuration of the vehicle 900 equipped with a power storage device 1 in the embodiment of the present disclosure. In FIG. 1, for simplification, members, such as tires, are not illustrated.

The vehicle 900 includes a vehicle body 910, the power storage device 1, and a share panel 230. The power storage device 1 is fixed to the vehicle body 910. Specifically, the power storage device 1 is fixed to an underbody 911 of the vehicle body 910. The underbody 911 includes a right frame 911b and a left frame 911a. The power storage device 1 is fixed to the right frame 911b and the left frame 911a by, for example, bolt fastening. The vehicle 900 includes, for example, a plug-in hybrid electric vehicle (PHEV), a battery electric vehicle (BEV), or a fuel cell electric vehicle (FCEV). The underbody 911 and the share panel 230 are examples of a “bottom portion” and a “cover member” of the present disclosure, respectively.

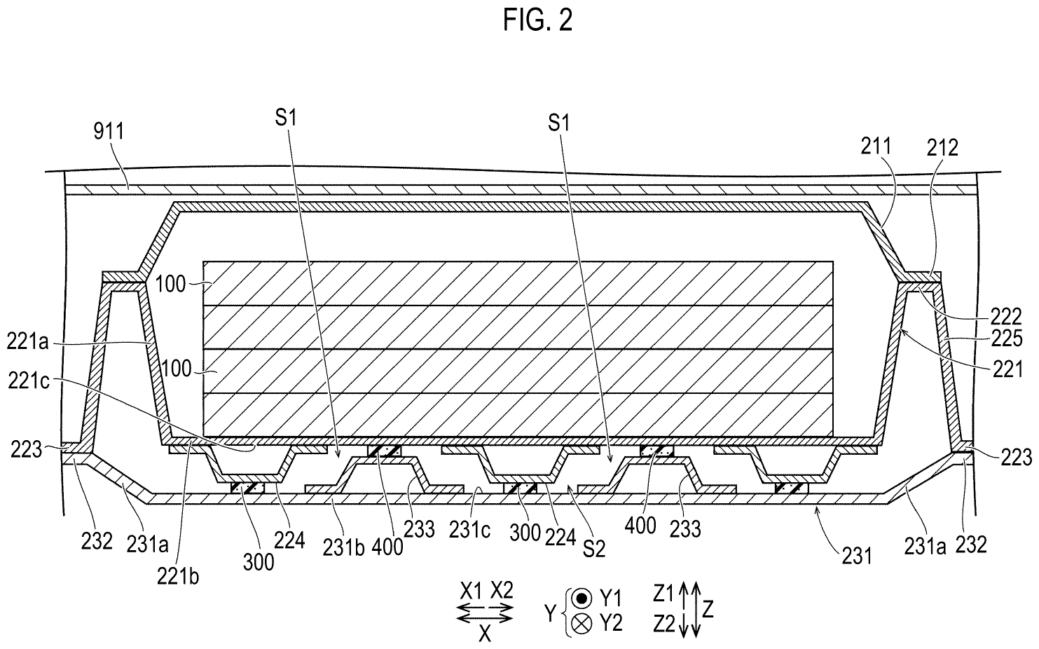

The power storage device 1 is, for example, a device that stores power for driving the vehicle 900. The power storage device 1 includes a plurality of power storage modules 100, a case 200, a plurality of dampers 300 (FIG. 2), and a plurality of dampers 400 (FIG. 2). The power storage modules 100 are housed in the case 200. The damper 300 and the damper 400 are examples of a “first buffer member” and a “second buffer member” of the present disclosure, respectively.

The case 200 includes an upper cover 210 and a lower case 220. The upper cover 210 is provided to cover the power storage modules 100 from a Z1 side. The lower case 220 supports the power storage modules 100 from a Z2 side.

The share panel 230 is provided below the case 200. The share panel 230 is provided to cover the case 200 (lower case 220) from below.

A support portion 220b is provided on a side surface 220a of the lower case 220 on a Y1 side. The support portion 220b is fixed (fastened) to the left frame 911a. In 25 addition, although not shown in FIG. 1, a support portion fixed (fastened) to the right frame 911b is provided on a side surface of the lower case 220 on a Y2 side. As a result, the power storage device 1 is fixed to the underbody 911. The method of fixing the power storage device 1 to the underbody 911 is not limited to the above example.

The share panel 230 is provided with a plurality of protrusions 233. Details of the protrusion 233 will be described below.

FIG. 2 is a cross-sectional view showing the power storage device 1 in the embodiment of the present disclosure. The power storage modules 100 are stacked in the Z direction. Each of the power storage modules 100 includes a plurality of electrodes (for example, bipolar electrodes) (not shown) stacked in the Z direction and a separator (not shown) disposed between the electrodes. A current collector, a heat conductive material, or the like (not shown) is disposed between the power storage modules 100 that are stacked. Note that Y1 indicates a front side of a paper surface, and Y2 indicates a back side of the paper surface.

The upper cover 210 (FIG. 1) includes an upper cover body portion 211 and a connection portion 212. The connection portion 212 constitutes an end portion (end surface) on the Z2 side of the upper cover 210. The connection portion 212 is formed, for example, in a ring shape. The upper cover body portion 211 is formed to protrude from an inner peripheral edge of the connection portion 212 toward the Z1 side.

The lower case 220 (FIG. 1) includes a lower case body portion 221, a connection portion 222, a pair of connection portions 223, and a plurality of (three in FIG. 2) protrusions 224. The lower case 220 is formed of a steel plate (for example, an iron plate). The protrusions 224 may be formed of a high-tensile steel sheet. The lower case body portion 221 and the protrusion 224 are examples of a “case body portion” and a “first protrusion” of the present disclosure, respectively.

The connection portion 222 is fastened to the connection portion 212 of the upper cover 210 by a bolt or the like (not shown). As a result, the lower case 220 is fixed to the upper cover 210. Similarly to the connection portion 212, the connection portion 222 is formed, for example, in a ring shape.

The lower case body portion 221 is formed to be recessed from an inner peripheral edge of the connection portion 222 toward the Z2 side. As a result, a housing space in which the power storage modules 100 are housed is formed between the lower case body portion 221 and the upper cover body portion 211.

Specifically, the lower case body portion 221 includes a side portion 221a and a bottom portion 221b. The side portion 221a extends from the inner peripheral edge of the connection portion 222 to the Z2 side. The side portion 221a is provided to surround the power storage modules 100 as viewed from the Z1 side. The bottom portion 221b is connected to a lower end portion of the side portion 221a. In other words, the side portion 221a extends from an outer peripheral edge of the bottom portion 221b to the Z1 side. The bottom portion 221b extends to be orthogonal to the Z direction.

The connection portions 223 are fastened to connection portions 232 (described below) of the share panel 230 by a bolt or the like (not shown). As a result, the share panel 230 is fixed to the lower case 220. One of the connection portions 223 is provided on an X1 side of the lower case body portion 221 and the other of the connection portions 223 is provided on an X2 side of the lower case body portion 221.

Each of the connection portions 223 is positioned below the bottom portion 221b of the lower case body portion 221. That is, each of the connection portions 223 constitutes an end portion (end surface) on the Z2 side of the lower case 220. Each of the connection portions 223 is connected to an outer peripheral edge of the connection portion 222 by a linking portion 225.

Each of the protrusions 224 is formed to protrude in a direction of the Z2 side toward the share panel 230 (a bottom portion 231b described below). Each of the protrusions 224 is fixed to the lower case body portion 221. Specifically, each of the protrusions 224 is fixed to a lower surface 221c of the bottom portion 221b of the lower case body portion 221. For example, each of the protrusions 224 is fixed to the lower surface 221c by welding.

The share panel 230 includes a share panel body portion 231, a pair of the connection portions 232, and the protrusions 233 (two in FIG. 2). The share panel body portion 231 connects the connection portions 232 to each other. The share panel 230 is formed of a steel plate (for example, an iron plate). The protrusions 233 may be formed of a high-tensile steel sheet. In addition, the share panel body portion 231 and the protrusion 233 are examples of a “cover body portion” and a “second protrusion” of the present disclosure, respectively.

The connection portions 232 are fastened to the connection portions 223 of the lower case 220 by a bolt or the like (not shown). As a result, the share panel 230 is fixed to the lower case 220. One of the connection portions 232 is provided on the X1 side of the share panel body portion 231 and the other of the connection portions 232 is provided on the X2 side of the share panel body portion 231.

The share panel body portion 231 is formed to be recessed toward the Z2 side with respect to the connection portions 232. As a result, a space in which the protrusions 224 and the protrusions 233 are disposed is formed between the lower case 220 (lower case body portion 221) and the share panel body portion 231.

Specifically, the share panel body portion 231 includes a pair of side portions 231a and a bottom portion 231b. One of the side portions 231a extends from an end portion on the share panel body portion 231 side of the connection portion 232 on the X1 side to the Z2 side. The other of the side portions 231a extends from an end portion on the share panel body portion 231 side of the connection portion 232 on the X2 side to the Z2 side. The bottom portion 231b connects lower end portions of the side portions 231a to each other. The bottom portion 231b extends to be orthogonal to the Z direction.

In a power storage device in the related art, a protective member or the like mitigates an impact from a side to the power storage device (power storage module), but there is room for improvement in mitigating an impact from below.

In the present embodiment, each of the protrusions 233 is formed to protrude in a direction of the Z1 side toward the lower case 220 (bottom portion 221b). That is, the protrusion 224 and the protrusion 233 of which protrusion directions are opposite to each other are provided between the lower case 220 and the share panel 230.

Each of the protrusions 233 is fixed to the share panel body portion 231. Specifically, each of the protrusions 233 is fixed to an upper surface 231c of the bottom portion 231b of the share panel body portion 231. For example, each of the protrusions 233 is fixed to the upper surface 231c by welding.

The protrusions 224 are disposed side by side in the X direction with a space S1 therebetween. The protrusions 233 are disposed side by side in the X direction with a space S2 therebetween. The space S1 and the space S2 are examples of a “first space” and a “second space” of the present disclosure, respectively.

Each of the protrusions 233 protrudes at a position overlapping the space S1 in the Z direction. Specifically, a protruding portion 233b (described below) of each of the protrusions 233 enters the space S1 from the Z2 side.

A central protrusion 224 in the X direction among the three protrusions 224 protrudes at a position overlapping the space S2 in the Z direction. Specifically, a protruding portion 224b (described below) of the central protrusion 224 enters the space S2 from the Z1 side.

Each of the dampers 300 is disposed between the protrusion 224 and the share panel 230 (bottom portion 231b). That is, the damper 300 is disposed between each of the protrusions 224 and the share panel 230 (bottom portion 231b).

Each of the dampers 400 is disposed between the protrusion 233 and the lower case 220 (bottom portion 221b). That is, the damper 400 is disposed between each of the protrusions 233 and the lower case 220 (bottom portion 221b).

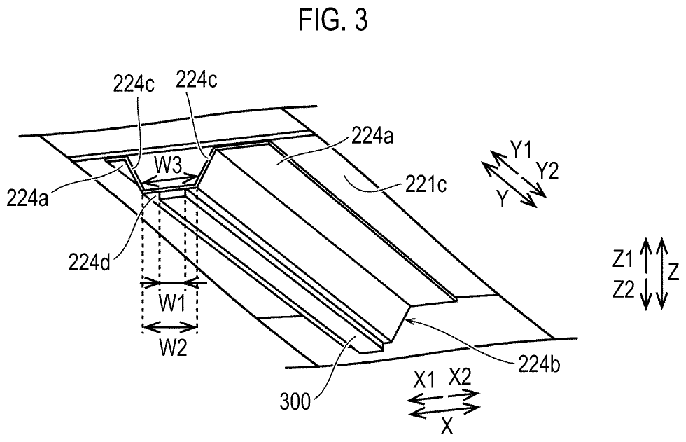

FIG. 3 is a perspective view showing a detailed configuration of the protrusion 224 and the damper 300. The protrusion 224 is formed to extend in the Y direction. That is, the protrusion 224 is provided to extend in the right-left direction of the vehicle 900.

The protrusion 224 has a hat-shaped cross section taken along the X direction, as shown in FIG. 2. Specifically, the protrusion 224 includes a pair of flange portions 224a and the protruding portion 224b. The protruding portion 224b is integrally (continuously) formed with each of the flange portions 224a. The flange portion 224a and the protruding portion 224b are examples of a “first flange portion” and a “first protruding portion” of the present disclosure, respectively.

Each of the flange portions 224a is fixed to the lower surface 221c of the lower case body portion 221. Each of the flange portions 224a has a flat plate shape extending along the lower surface 221c. That is, each of the flange portions 224a extends to be orthogonal to the Z direction.

The protruding portion 224b protrudes in the direction of the Z2 side toward the share panel 230 (FIG. 1) from the flange portions 224a. The protruding portion 224b is disposed between the flange portions 224a in the X direction and is connected to each of the flange portions 224a. Specifically, one of the flange portions 224a is connected to an end portion on the X1 side of the protruding portion 224b. The other of the flange portions 224a is connected to an end portion on the X2 side of the protruding portion 224b.

The protruding portion 224b includes a pair of inclined portions 224c and a lower end portion 224d. One of the inclined portions 224c extends from an end portion on the X2 side of the flange portion 224a on the X1 side to the Z2 side. The other of the inclined portions 224c extends from an end portion on the X1 side of the flange portion 224a on the X2 side to the Z2 side. The lower end portion 224d is an example of a “lower end of a first protrusion” of the present disclosure.

The lower end portion 224d is provided at a lower end of the protruding portion 224b. Specifically, the lower end portion 224d connects lower end portions of the inclined portions 224c to each other.

The lower end portion 224d extends to be orthogonal to the Z direction. In addition, each of the inclined portions 224c extends to intersect with the Z direction without being orthogonal to the Z direction. The lower end portion 224d is disposed at a position that does not overlap the flange portions 224a (and the inclined portions 224c) as viewed from the Z2 side.

The damper 300 is fixed to the lower end portion 224d from the Z2 side. That is, the damper 300 is provided between the lower end portion 224d and the share panel 230 (bottom portion 231b (FIG. 2)).

The damper 300 extends in the Y direction along the protrusion 224 (lower end portion 224d). A width W1 of the damper 300 in the X direction is smaller than a width W2 of the lower end portion 224d in the X direction.

A width W3 of the protruding portion 224b in the X direction gradually decreases as the protruding portion 224b extends to the Z2 side. A cross section (FIG. 2) of the protruding portion 224b along the X direction has a trapezoidal shape. A minimum value of the width W3 is equal to the width W2 of the lower end portion 224d.

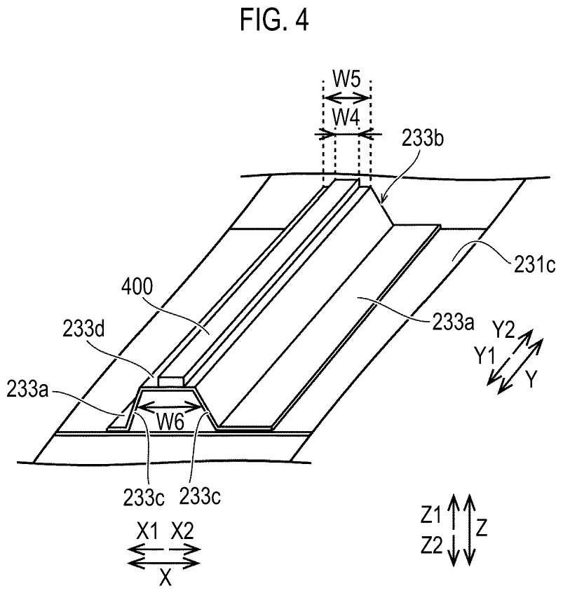

FIG. 4 is a perspective view showing a detailed configuration of the protrusion 233 and the damper 400. The protrusion 233 has the same shape (configuration) as the protrusion 224. The protrusion 233 is formed to extend in the Y direction. That is, the protrusion 233 is provided to extend in the right-left direction of the vehicle 900.

The protrusion 233 includes a pair of flange portions 233a and a protruding portion 233b. The protruding portion 233b is integrally (continuously) formed with each of the flange portions 233a. The flange portion 233a and the protruding portion 233b are examples of a “second flange portion” and a “second protruding portion” of the present disclosure, respectively.

Each of the flange portions 233a is fixed to the upper surface 231c of the share panel body portion 231. Each of the flange portions 233a has a flat plate shape extending along the lower surface 221c. That is, each of the flange portions 233a extends to be orthogonal to the Z direction.

The protruding portion 233b protrudes in the direction of the Z1 side toward the lower case 220 (FIG. 1) from the flange portions 233a. The protruding portion 233b is disposed between the flange portions 233a in the X direction and is connected to each of the flange portions 233a. Specifically, one of the flange portions 233a is connected to an end portion on the X1 side of the protruding portion 233b. The other of the flange portions 233a is connected to an end portion on the X2 side of the protruding portion 233b.

The protruding portion 233b includes a pair of inclined portions 233c and an upper end portion 233d. One of the inclined portions 233c extends from an end portion on the X2 side of the flange portion 233a on the X1 side to the Z1 side. The other of the inclined portions 233c extends from an end portion on the X1 side of the flange portion 233a on the X2 side to the Z1 side. The upper end portion 233d is an example of an “upper end of a second protrusion” of the present disclosure.

The upper end portion 233d is provided at an upper end of the protruding portion 233b. Specifically, the upper end portion 233d connects upper end portions of the inclined portions 233c to each other.

The upper end portion 233d extends to be orthogonal to the Z direction. In addition, each of the inclined portions 233c extends to intersect with the Z direction without being orthogonal to the Z direction. The upper end portion 233d is disposed at a position that does not overlap the flange portions 233a (and the inclined portions 233c) as viewed from the Z1 side.

The damper 400 is fixed to the upper end portion 233d from the Z1 side. That is, the damper 400 is provided between the upper end portion 233d and the lower case 220 (bottom portion 221b).

The damper 400 extends in the Y direction along the protrusion 233 (upper end portion 233d). A width W4 of the damper 400 in the X direction is smaller than a width W5 of the upper end portion 233d in the X direction.

A width W6 of the protruding portion 233b in the X direction gradually decreases as the protruding portion 233b extends to the Z1 side. A cross section (FIG. 2) of the protruding portion 233b along the X direction has a trapezoidal shape. A minimum value of the width W6 is equal to the width W5 of the upper end portion 233d.

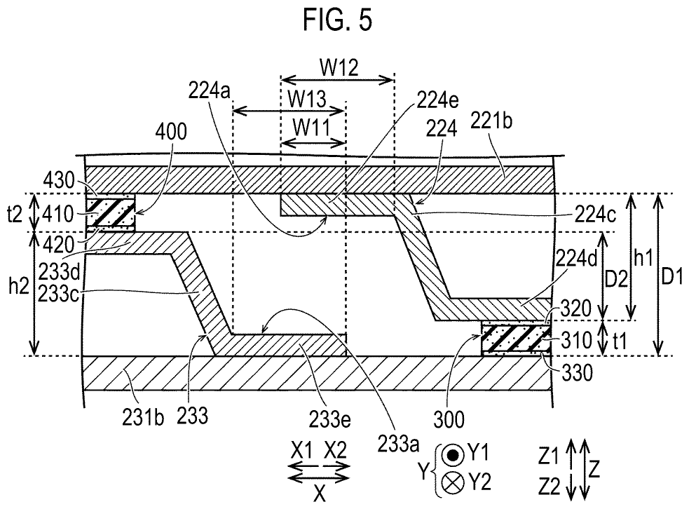

FIG. 5 is a partially enlarged view of FIG. 2. The damper 300 includes a buffer layer 310, an adhesive layer 320, and an adhesive layer 330.

The buffer layer 310 is formed of a foaming material, such as a sponge. Hardness of the damper 300 can be adjusted by adjusting a foaming rate in the buffer layer 310. For example, when it is significant to prevent an abnormal sound from the damper 300, the buffer layer 310 is formed to be relatively soft. In addition, when it is significant to improve rigidity via the damper 300, the buffer layer 310 is formed to be relatively rigid.

The adhesive layer 320 is formed on an upper surface of the buffer layer 310. As a result, the damper 300 (buffer layer 310) is fixed to the protrusion 224 (lower end portion 224d) by the adhesive layer 320.

The adhesive layer 330 is formed on a lower surface of the buffer layer 310. As a result, the damper 300 (buffer layer 310) is fixed to the share panel 230 by the adhesive layer 330. Therefore, the protrusion 224 (lower end portion 224d) is fixed to the share panel 230.

Each of the adhesive layer 320 and the adhesive layer 330 may be formed of an adhesive material, or may be formed of an adhesive tape (double-sided tape). In addition, in order to remove the share panel 230 from the lower case 220 during maintenance or the like, at least one of the adhesive layer 320 and the adhesive layer 330 may be configured to allow for detachment of the adhesive. For example, at least one of the adhesive layer 320 and the adhesive layer 330 may be formed to be relatively thin.

The damper 400 has the same configuration as the damper 300. The damper 400 has a buffer layer 410, an adhesive layer 420, and an adhesive layer 430.

The buffer layer 410 is formed of a foaming material, such as a sponge. The adhesive layer 420 is formed on a lower surface of the buffer layer 410. As a result, the damper 400 (buffer layer 410) is fixed to the protrusion 233 (upper end portion 233d) by the adhesive layer 420.

The adhesive layer 430 is formed on an upper surface of the buffer layer 410. As a result, the damper 400 (buffer layer 410) is fixed to the lower case 220 by the adhesive layer 430. Therefore, the protrusion 233 (upper end portion 233d) is fixed to the lower case 220. In addition, in order to remove the share panel 230 from the lower case 220 during maintenance or the like, at least one of the adhesive layer 420 and the adhesive layer 430 may be configured to allow for detachment of the adhesive. For example, at least one of the adhesive layer 420 and the adhesive layer 430 may be formed to be relatively thin.

The protrusion 224 has a height h1 in the Z direction. The damper 300 has a thickness t1 (for example, several mm) in the Z direction. The height h1 is greater than the thickness t1. The sum of the height h1 and the thickness t1 is equal to a distance D1 between the bottom portion 221b of the lower case 220 and the bottom portion 231b of the share panel 230.

The protrusion 233 has a height h2 in the Z direction. The damper 400 has a thickness t2 (for example, several mm) in the Z direction. The height h2 is greater than the thickness t2. The height h2 is equal to the height h1 of the protrusion 224. The thickness t2 is equal to the thickness t1 of the damper 300.

The lower end portion 224d of the protrusion 224 is positioned on the Z2 side with respect to the upper end portion 233d of the protrusion 233. Specifically, the lower end portion 224d (a lower surface of the lower end portion 224d) and the upper end portion 233d (an upper surface of the upper end portion 233d) are separated from each other by a distance D2 in the Z direction. The distance D2 is larger than half the distance D1 between the bottom portion 221b of the lower case 220 and the bottom portion 231b of the share panel 230.

A part of the flange portion 224a of the protrusion 224 overlaps a part of the flange portion 233a of the protrusion 233 in the Z direction. The flange portion 224a includes an overlapping portion 224e that overlaps the flange portion 233a in the Z direction.

In the protrusion 224 interposed between the protrusions 233 in the X direction, the overlapping portion 224e is provided in each of the flange portions 224a. Meanwhile, in the other protrusions 224, the overlapping portion 224e is provided solely on the flange portion 224a on one side (protrusion 233 side) in the X direction.

In addition, the flange portion 233a includes an overlapping portion 233c that overlaps the flange portion 224a in the Z direction. The overlapping portion 233e is provided in each of the flange portions 233a.

Each of the overlapping portion 224e and the overlapping portion 233e has a width W11 in the X direction. The width W11 is larger than half a width W12 of the flange portion 224a in the X direction (a width W13 of the flange portion 233a in the X direction). The width W12 and the width W13 are equal to each other.

Each of the flange portions 224a does not overlap the protruding portion 233b (FIG. 4) of the protrusion 233 in the Z direction. As a result, it is possible to suppress excessive reduction in gap between the protrusion 224 and the protrusion 233 in the Z direction due to the flange portion 224a and the protruding portion 233b overlapping in the Z direction.

Each of the flange portions 233a does not overlap the protruding portion 224b (FIG. 3) of the protrusion 224 in the Z direction. As a result, it is possible to suppress excessive reduction in gap between the protrusion 224 and the protrusion 233 in the Z direction due to the flange portion 233a and the protruding portion 224b overlapping in the Z direction.

As can be seen from the above description, the protruding portion 224b (FIG. 3) of the protrusion 224 and the protruding portion 233b (FIG. 4) of the protrusion 233 do not overlap each other in the Z direction, and are shifted in position from each other in the X direction.

As described above, in the present embodiment, the lower case 220 includes the protrusion 224 that protrudes in the direction of the Z2 side toward the share panel 230. The share panel 230 includes the protrusion 233 that protrudes in the direction of the Z1 side toward the lower case 220. As a result, each of the protrusion 224 and the protrusion 233 functions as a buffer member against the impact from below, so that the impact from below can be effectively mitigated as compared with a case where any one of the protrusion 224 and the protrusion 233 is not provided. As a result, it is possible to suppress the transmission of the impact to the power storage module 100.

In the embodiment, an example has been described in which the protrusion 233 is disposed at a position overlapping, in the Z direction, the space S1 between the protrusions 224 arranged in the X direction, but the present disclosure is not limited thereto. The protrusion 224 and the protrusion 233 may be disposed in the same region as viewed in the Z direction.

In the embodiment, an example has been described in which the protrusions 224 and the protrusions 233 are provided, but the present disclosure is not limited thereto. The number of either or both of the protrusions 224 and the protrusions 233 may be one.

In the embodiment, an example has been described in which the damper 300 is adhered (fixed) to each of the protrusion 224 and the share panel 230, but the present disclosure is not limited thereto. The damper 300 may be adhered (fixed) to solely one of the protrusion 224 and the share panel 230. Similarly, the damper 400 may be adhered (fixed) to solely one of the protrusion 233 and the lower case 220.

In the embodiment, an example has been described in which the protrusion 224 is fixed to the share panel 230 by the damper 300, but the present disclosure is not limited thereto. The protrusion 224 may be directly fixed to the share panel 230 without using the damper 300. For example, the protrusion 224 may be directly joined to the share panel 230 by an adhesive material, or the protrusion 224 may be welded to the share panel 230. Similarly, the protrusion 233 may be directly fixed to the lower case 220 without using the damper 400.

In the embodiment, an example has been described in which the flange portions 224a are provided in a pair on each of the X1 side and the X2 side of the protruding portion 224b, but the present disclosure is not limited thereto. The protrusion provided on the lower case 220 may include a protruding portion and an annular flange portion provided to surround the protruding portion. In addition, the protrusion provided on the share panel 230 side may be configured in the same manner.

In the embodiment, an example has been described in which a part of the flange portion 224a and a part of the flange portion 233a overlap in the Z direction, but the present disclosure is not limited thereto. Any one of the flange portion 224a and the flange portion 233a may entirely overlap the other of the flange portion 224a and the flange portion 233a in the Z direction.

An example has been described in which each of the protrusion 224 and the protrusion 233 extends in the right-left direction of the vehicle 900, the present disclosure is not limited thereto. Each of the protrusion 224 and the protrusion 233 may extend in the front-rear direction of the vehicle 900. In addition, the direction in which the protrusion 233 extends and the direction in which the protrusion 224 extends may intersect with each other.

In addition, at least one of the protrusion 224 and the protrusion 233 may be divided into a plurality of parts in the direction in which the at least one of the protrusion 224 and the protrusion 233 extends. In this case, the damper 300 (400) may be similarly divided into a plurality of parts. In addition, a plurality of dampers may be provided side by side on a single protrusion. In this case, the dampers are preferably provided at least at both ends and the center of the protrusion in the direction in which the protrusion extends.

In the embodiment, an example has been described in which the height h1 of the protrusion 224 and the height h2 of the protrusion 233 are equal to each other, but the present disclosure is not limited thereto. The height h1 and the height h2 may be different from each other.

In the embodiment, an example has been described in which the protrusion 224 is a separate member from the lower case body portion 221, but the present disclosure is not limited thereto. The protrusion 224 may be integrally formed with the lower case body portion 221. For example, the lower case body portion may be deformed to form the protrusion. In addition, the protrusion 233 may be integrally formed with the share panel body portion 231 in the same manner. For example, the share panel body portion may be deformed to form the protrusion.

In the embodiment, an example has been described in which the cross section of each of the protrusion 224 and the protrusion 233 along the X direction has a hat shape, but the present disclosure is not limited thereto. For example, the cross section of at least one of the protrusion 224 and the protrusion 233 along the X direction may have a rectangular shape, and a recess may be formed in a part of the protruding portion.

In the embodiment, an example has been described in which each of the flange portions 224a does not overlap the protruding portion 233b of the protrusion 233 in the Z direction, but the present disclosure is not limited thereto. The flange portion 224a may overlap the protruding portion 233b in the Z direction. In addition, similarly, the flange portion 233a may overlap the protruding portion 224b of the protrusion 224 in the Z direction.

The configurations of the embodiment and the various modification examples may be combined with each other.

The embodiment disclosed herein is merely illustrative and not restrictive in all respects. The scope of the present disclosure is defined by the terms of the claims, rather than the above description of the embodiment, and is intended to include any modifications within the scope and meaning equivalent to the terms of the claims.

What is claimed is:

1. A vehicle comprising:
a vehicle body;
a power storage device; and
a cover member, wherein:
the power storage device includes a power storage module and a lower case, the power storage device being fixed to a bottom portion of the vehicle body;
the lower case includes at least one first protrusion that protrudes downward toward the cover member, the lower case being configured to support the power storage module; and
the cover member includes at least one second protrusion that protrudes upward toward the lower case, the cover member being configured to cover the power storage device from below and cover the lower case from below.

2. The vehicle according to claim 1, wherein:
the at least one first protrusion includes a plurality of first protrusions disposed side by side with a first space interposed between the first protrusions; and
the at least one second protrusion protrudes at a position overlapping the first space in an up-down direction.

3. The vehicle according to claim 1, wherein:
the at least one second protrusion includes a plurality of second protrusions disposed side by side with a second space interposed between the second protrusions; and
the at least one first protrusion protrudes at a position overlapping the second space in an up-down direction.

4. The vehicle according to claim 1, wherein:
the at least one first protrusion is fixed to the lower case; and
the at least one second protrusion is fixed to the cover member.

5. The vehicle according to claim 1, further comprising:
a first buffer member provided between the at least one first protrusion and the cover member; and
a second buffer member provided between the at least one second protrusion and the lower case.

6. The vehicle according to claim 5, wherein:
the first buffer member is fixed to at least one of the at least one first protrusion and the cover member; and
the second buffer member is fixed to at least one of the at least one second protrusion and the lower case.

7. The vehicle according to claim 1, wherein:
the lower case includes a case body portion to which the at least one first protrusion is fixed;
the cover member includes a cover body portion to which the at least one second protrusion is fixed;
the at least one first protrusion includes
a first flange portion fixed to the case body portion, and
a first protruding portion that protrudes downward from the first flange portion toward the cover member; and
the at least one second protrusion includes
a second flange portion fixed to the cover body portion, and
a second protruding portion that protrudes upward from the second flange portion toward the lower case.

8. The vehicle according to claim 7, wherein at least a part of the first flange portion overlaps at least a part of the second flange portion in an up-down direction.

9. The vehicle according to claim 1, wherein a lower end of the at least one first protrusion is positioned below an upper end of the at least one second protrusion.

10. The vehicle according to claim 1, wherein each of the at least one first protrusion and the at least one second protrusion is provided to extend in a front-rear direction or a right-left direction of the vehicle body.
